(19) United States
(12) Patent Application Publication
(10) Pub. No.: US 2004/0088857 A1
(43) Pub. Date: May 13, 2004

(54) Method of joining wire

(75) Inventors: Kei Fujimoto, Haibara-gun (JP); Masanori Onuma, Haibara-gun (JP)

Correspondence Address: SUGHRUE MION, PLLC, 2100 PENNSYLVANIA AVENUE, N.W., SUITE 800, WASHINGTON, DC, 20037, US

(73) Assignee: YAZAKI CORPORATION

(21) Appl. No.: 10/652,251

(22) Filed: Sep. 2, 2003

(30) Foreign Application Priority Data
Aug. 30, 2002 (JP) P2002-253643

(51) Int. Cl. H01R 43/00

(52) U.S. Cl. 29/871; 29/868

(57) ABSTRACT

A method of joining a wire includes the steps of: providing the wire having a conducting portion consisting of a plurality of core wires, restricting a width of the conducting portion, pressing the core wires of the conducting portion restricted in the restricting step, and joining the pressed core wires of the conducting portion each other so that the conducting portion is integrally formed into a flat plate-shape.

### BACKGROUND OF THE INVENTION

This invention relates to a method of joining a wire, in which for example, a twisted wire, having a plurality of conducting wires, is joined to a mating connection member such as a terminal.

There is known one related method of ultrasonic joining a twisted wire, in which a distal end portion of the twisted wire is beforehand fixed into a predetermined shape such as a semicircular shape, and thereafter this distal end portion is joined to a mating member by an ultrasonic welding machine (see, for example, JP-B-56-27996 (pages 1 to 3, FIGS. 1, 2 and 4)).

Namely, as shown in FIG. 6A, the distal end portion 101a of the twisted wire 101 is placed on a lower electrode 104a mounted on a fixing arm 104 of a resistance welding machine 102, and in this condition an upper electrode 103a, mounted on a moving arm 103, is moved downward, and the distal and portion 101a of the twisted wire 101 is pressed between the upper and lower electrodes 103a and 104a while energizing the two electrodes. As a result, the distal end portion 101a of the twisted wire 101 is fixed into a semi-circular shape as shown in FIG. 6B.

Then, a flat-type aluminum wire (mating connection member) 105 and the twisted wire 101 are placed on an anvil 110 of an ultrasonic welding machine 106 as shown in FIG. 7, and thereafter a tip 109 is pressed toward the anvil 110, so that the distal end portion 101a of the twisted wire 101, which has been integrally fixed as describe above, is fitted in a groove 109a in the tip 109.

Then, ultrasonic waves are applied from an ultrasonic wave-generating source 107 via a horn 108 and the tip 109 to the distal end portion 101a of the twisted wire 101 and the flat-type aluminum wire 105 to vibrate them, thereby joining them together as shown in FIG. 8.

However, when the distal end portion 101a of the twisted wire 101 is fixed into the semi-circular shape, and the joining is effected with the groove portion 109a of the tip 109 of the ultrasonic welding machine 106 held against this semi-circular portion as described above, there is encountered a problem that an upper portion of the semi-circular portion is rubbed in a concentrated manner, so that there is a fear that a conductor is cut.

Therefore, it may be proposed to keep the ultrasonic power to a low level so as to prevent the cutting of the conductor. However, this invites a problem that the strength of joining of the wire to the mating member is lowered.

It has also been proposed to fix a distal end portion of a twisted wire into a flat plate-shape (see, for example, JP-A-2001-68244 (pages 5 to 7, FIGS. 1 and 2)).

Namely, as shown in FIG. 9, a sheath 121 is removed from a distal end portion of a wire 120, thereby exposing a conductor 122, and the wire 120 is fixed to a holder 123. Then, a distal end portion 122a of the conductor 122 is held between a pair of welding electrodes 124 and 125 in an upward-downward direction.

Then, the distal end portion 122a of the conductor 122 is pressed by the pair of electrodes while energizing these electrodes, so that this distal end portion 122a is fixed into a flattened shape.

However, the conductor 122 of the wire 120 has a round transverse cross-section (round wire). Therefore when the distal end portion 122a of the conductor 122 is pressed to be fixed into the flattened shape as described above, the conductor 122 is spread into a generally fan-shape as shown by hatching in FIG. 10.

Therefore, in the case of joining the distal end portion of the wire 120, for example, to a welding terminal 126 as shown in FIG. 11, there is a fear that a width W3 of the distal end portion 122a of the conductor 122 is larger than the distance W4 between a pair of side walls 127 of the welding terminal 126, so that the distal end portion 122a can not be set in this welding terminal.

And besides, even when the distal end portion 122a of the conductor 122 is inserted between the two side walls 127, the area of contact between the distal end portion 122a and the welding conductor 126 deviates from a predetermined value if the width W3 of the distal end portion 122a of the conductor 122 fails to have a predetermined value, and as a result there is encountered a problem that it is difficult to control the joining strength obtained by the ultrasonic welding.

### SUMMARY OF THE INVENTION

It is therefore an object of the present invention to provide a method of joining a wire, in which a high joining strength is obtained in a stable manner.

In order to achieve the above object, according to the present invention, there is provided a method of joining a wire, comprising the steps of:

providing the wire having a conducting portion consisting of a plurality of core wires;

restricting a width of the conducting portion;

pressing the core wires of the conducting portion restricted in the restricting step; and

joining the pressed core wires of the conducting portion each other so that the conducting portion is integrally formed into a flat plate-shape.

Preferably, ultrasonic vibration is applied to the pressed core wires in the joining step.

Preferably, the method further comprises the steps of:

providing a connection member;

setting the conducting portion of the wire to the connection member: and

applying ultrasonic to the conducting portion and the connection member so as to join each other.

In the above methods, first, a distal end portion of the wire, including the plurality of core wires, is fixed into the flat plate-shape having the predetermined width, and then this distal end portion is ultrasonic joined to the connection member by the use of an ultrasonic joining machine or the like.

Namely, a sheath is removed from the distal end portion of the wire, thereby exposing the conducting portion, and then this conducting portion is kept to the desired joining width so that this conducting portion will not spread right and left. In this condition, the core wires are pressed in the direction perpendicular to the direction of the width, and are joined together, so that this conducting portion is integrally formed into the flat plate-shape. Thereafter, the conducting portion, thus integrally formed into the flat plate-shape, is ultrasonic joined to the mating connection member.

Therefore, the plurality of core wires can be integrally formed into the flat plate-shape such that the integrally-formed conducting portion has the desired width corresponding to the joining width of the connection member. Therefore, the conducting portion can be positively joined to the connection member in such a manner that the core wires will not become loose or untidy.

And besides, the area of contact between the conducting portion of the wire and the connection member (which are to be ultrasonic joined together) can be kept to the predetermined value, and therefore there is no fear that the ultrasonic power can not be suitably applied to the joining portion because of variations in this contact area, and this eliminates the possibility of the defective joining, and therefore the ultrasonic joining can be suitably effected by the ultrasonic joining machine.

Therefore, there can be provided the wire joining method in which the high joining strength is obtained in a stable manner.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1A is a schematic view explanatory of a preparatory step of one preferred embodiment of a wire-ultrasonic joining method of the invention, and

FIG. 1B is a perspective view showing a condition of a wire in this step;

FIG. 2A is a schematic view explanatory of a wire-inserting step of the wire-ultrasonic joining method of the above embodiment, and

FIG. 2B is a perspective view showing the condition of the wire in this step;

FIG. 3A is a schematic view explanatory of a wire-pressing step of the wire-ultrasonic joining method of the above embodiment, and

FIG. 3B is a perspective view showing the condition of the wire in this step;

FIG. 4A is an enlarged perspective view showing a conducting portion of the wire integrally formed into a flat plate-shape, and

FIG. 4B is an enlarged perspective view showing a modified conducting portion;

FIG. 5 is a perspective view of an important portion, showing an ultrasonic joining step of the wire-ultrasonic joining method of the above embodiment;

FIG. 6A is a schematic view showing a related process of integrally fixing a distal end portion of a wire, and

FIG. 6B is a perspective view showing the wire having the integrally-formed distal end portion;

FIG. 7 is a schematic view showing a process of ultrasonic joining the distal end portion of the wire of FIG. 6;

FIG. 8 is a perspective view showing a finished product obtained by the production process of FIGS. 6 and 7;

FIG. 9 is a front-elevational view showing a related process of forming a conducting portion of a wire into a flat plate-shape;

FIG. 10 is a plan view of the conducting portion of FIG. 9; and

FIG. 11 is a perspective view explanatory of a problem with the conducting portion of FIG. 10.

### DETAILED DESCRIPTION OF THE PREFERRED EMBODIMENTS

One preferred embodiment of a wire-ultrasonic joining method of the present invention will now be described in detail with reference to the drawings.

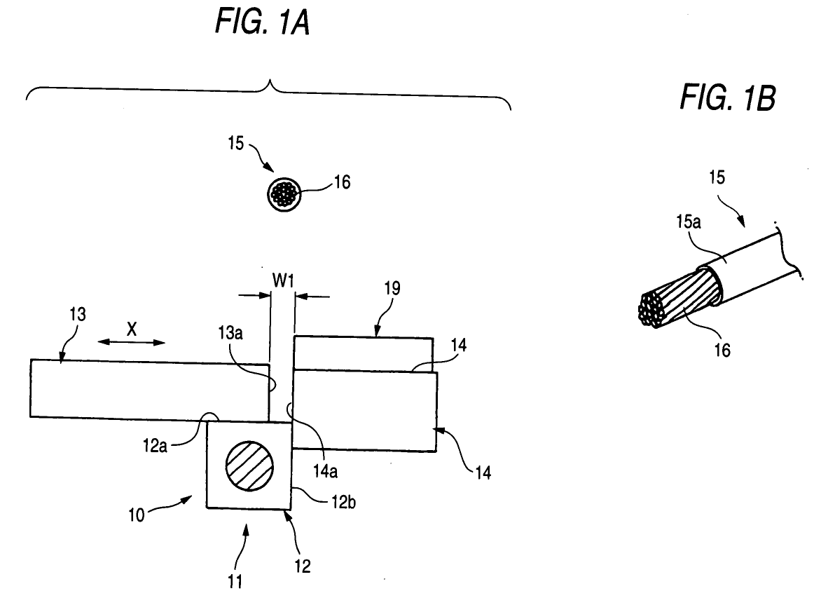

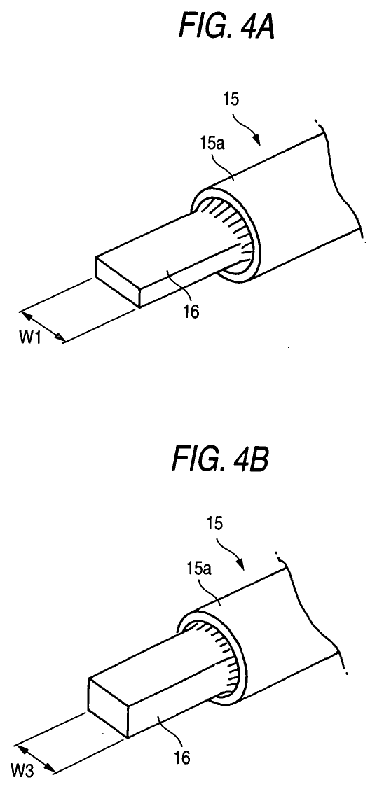

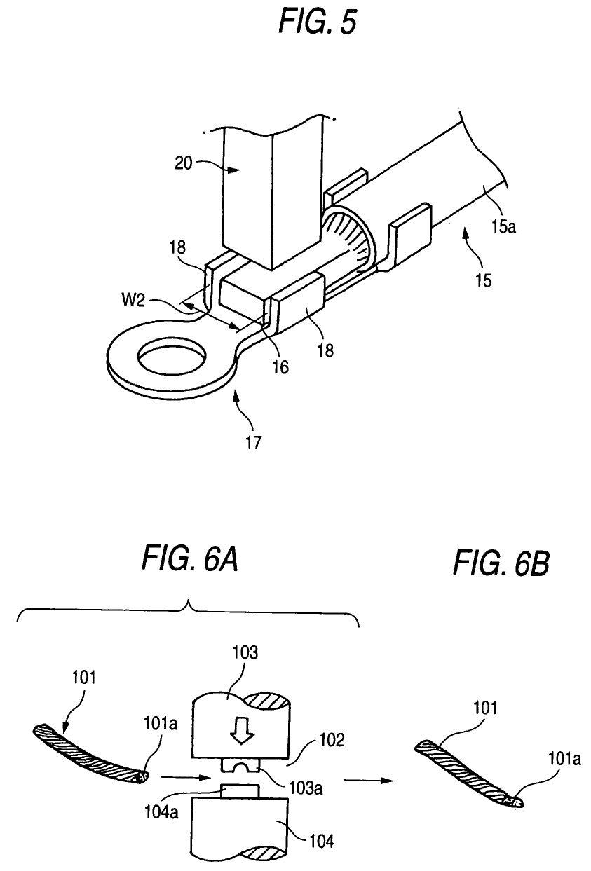

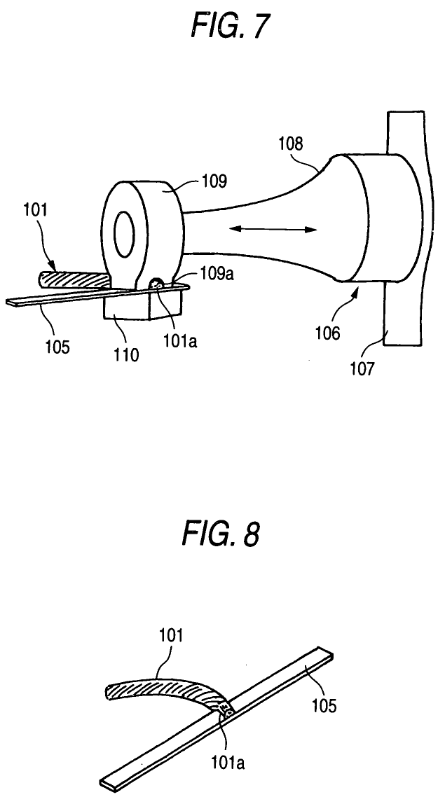

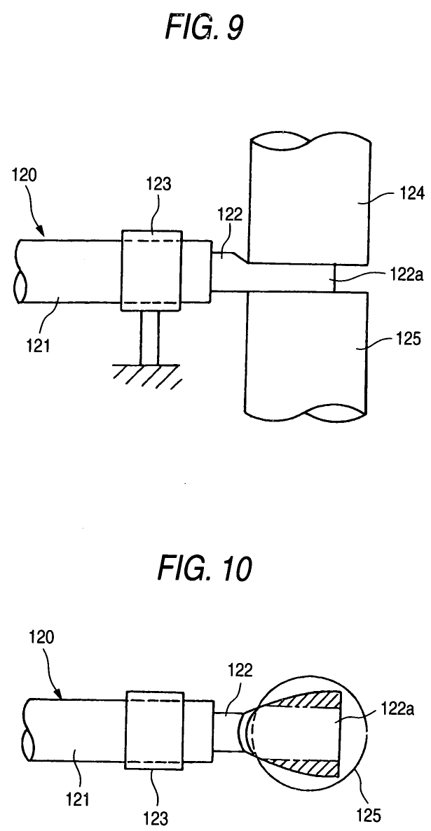

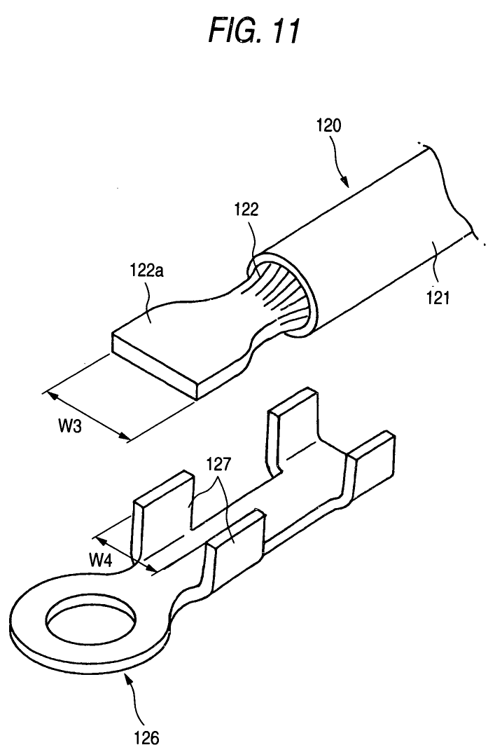

FIGS. 1 to 3 wire schematic views explanatory of one preferred embodiment of the wire-ultrasonic joining method of the invention, FIGS. 4A and 4B are enlarged perspective views showing examples of distal end portions of conducting portions each integrally formed into a flat plate-shape, and FIG. 5 is a perspective view explanatory of a process of connecting the conducting portion (integrally formed into the flat plate-shape) to a mating connection member.

First, in one preferred embodiment of the wire-ultrasonic joining method of the invention, a joining apparatus 10 for integrally forming the conducting portion of the wire into a flat plate-shape will be described with reference to FIGS. 1 to 3.

As shown in FIG. 1, this joining apparatus 10 includes an ultrasonic joining machine 11 provided with a vibration horn 12 of a rectangular cross-section, a first holding member 13 which is movable along an upper surface 12a of the vibration horn 12 in a horizontal direction (left-right direction in the drawings), and a second holding member 14 which is movable along a side surface 12b of the vibration horn 12 in a direction (upward-downward direction in the drawings) perpendicular to the direction of movement of the first holding member 13.

The distance W1 between an end surface 13a of the first holding member 13 and an end surface 14a of the second holding member 14 can be adjusted by moving the first holding member 13 along the upper surface 12a of the vibration horn 12, and this distance W1 determines a width of the conducting portion 16 of the wire 15 fixed into the flat plate-shape.

This width can be set, for example, to a joining width corresponding to the distance W2 between a pair of side walls 18 of a welding terminal 17 (see FIG. 5).

The first holding member 13 is provided with fixing member (not shown) with an adjusting function by which this first holding member 13 can be suitably located and fixed in a predetermined position on the upper surface 12a of the vibration horn 12.

A pressing member (movable anvil) 19 is mounted on the second holding member 14, and is movable along an upper surface 14b of the second holding member 14 in the same direction as the direction of movement of the first holding member 13. The pressing member 19 is movable upward and downward together with the second holding member 14.

Namely, the conducting portion 16 of the wire 15 is inserted into the gap (which has been set to the predetermined width W1) between the end surface 13a of the first holding member 13 and the end surface 14a of the second holding member 14. Thereafter, the pressing member 19 is moved left (in the drawings) along the upper surface 14b of the second holding member 14 until this pressing member 19 is brought into abutting engagement with the end surface 13a of the first holding member 13. Then, the second holding member 14 is moved downward (in the drawings), together with the pressing member 19, along the side surface 12b of the vibration horn 12, so that the pressing member 19 presses the conducting portion 16 of the wire 15 against the upper surface 12a of the vibration horn 12.

Next, the method of ultrasonic joining a wire according to the invention will be described.

First, in a preparatory step, the first holding member 13 is suitably moved in a direction of arrow X, thereby setting the distance W1 between the end surface 13a of the first holding member 13 and the end surface 14a of the second holding member 14 to a desired value, and then the first holding member 13 is fixed against movement as shown in FIG. 1A.

On the other hand, a sheath 15a is removed from the distal end portion of the wire 15 so that the conducting portion 16 consisting of a plurality of core wires is exposed as shown in FIG. 1B. In this condition, the conducting portion 16 is in the form of a twisted wire having a round cross-section.

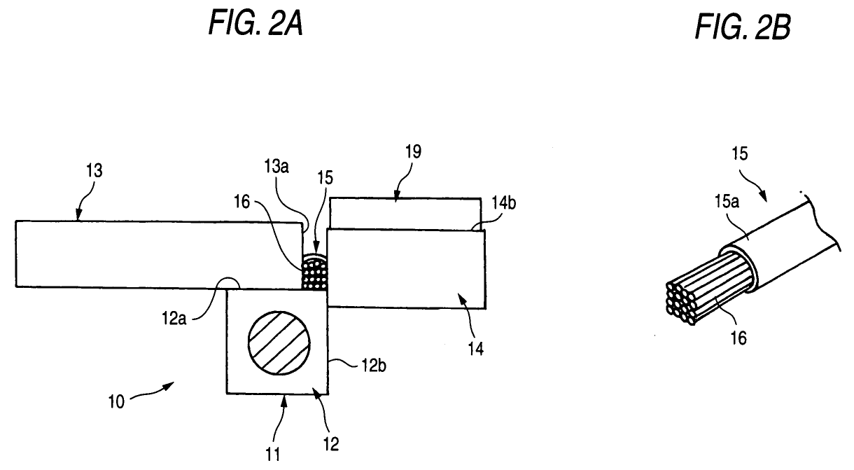

Then, in a wire-inserting step, the exposed conducting portion 16 is inserted into the gap (which is set to the value W1) between the end surface 13a of the first holding member 13 and the end surface 14a of the second holding member 14 as shown in FIG. 2A. At this time, although the twisted condition of the conducting portion 16 is released as shown in FIG. 2B, the conducting portion 16 will not become loose or untidy since this conducting portion 16 is held at its three sides by the vibration horn 12, the first holding member 13 and the second holding member 14.

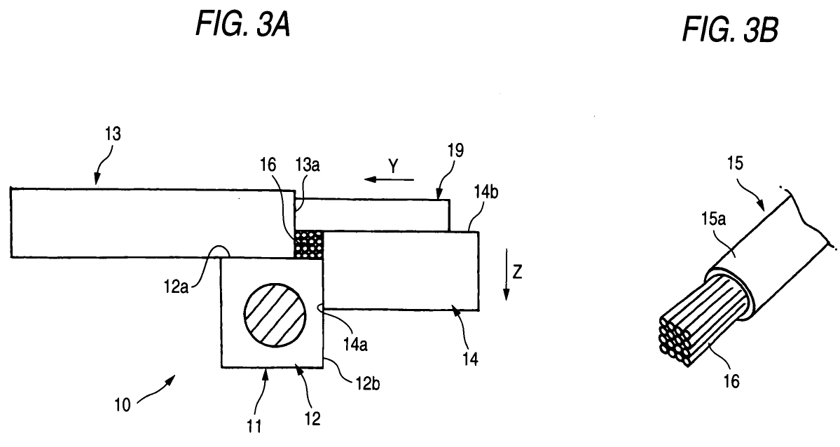

Then, in a wire-pressing step, the pressing member 19 is moved along the upper surface 14b of the second holding member 14 in a direction of arrow Y, so that the distal end surface of the pressing member 19 is brought into abutting engagement with the end surface 13a of the first holding member 13 as shown in FIG. 3A.

Then, the second holding member 14 is moved along the side surface 12b of the vibration horn 12 in a direction of arrow Z.

As a result, the pressing member 19 is moved in unison with the second holding member 14 in the direction of arrow Z, and therefore presses one surface (upper surface in FIG. 3A) of the conducting portion 16 inserted between the end surface 13a of the first holding member 13 and the end surface 14a of the second holding member 14, thereby forming the conducting portion 16 into a rectangular cross-sectional shape.

In this case, when the bundle-like conducting portion 16, consisting of the plurality of core wires, is pressed in the direction of the thickness thereof, the distal end portion of the conducting portion 16 tends to spread in the direction of the width thereof. However, this distal end portion can not spread since the opposite sides of this distal end portion are restricted by the first and second holding members 13 and 14, respectively.

Then, the ultrasonic joining apparatus 11 is operated to vibrate the vibration horn 12 (in opposite directions perpendicular to the sheet of the drawings), thereby ultrasonic joining the core wires of the conducting portion 16 together, so that the conducting portion 16 is integrally formed into the flat plate-shape having the desired width W1 as shown in FIG. 4A.

Then, in an ultrasonic-joining step, the conducting portion 16 is set, for example, between the pair of side walls 18 of the welding terminal (mating connection member) 17 as shown in FIG. 5, and this conducting portion 16 is vibrated by a vibration horn 20 of an ultrasonic joining machine while it is pressed by this vibration horn 20, thereby ultrasonic joining the conducting portion 16 to the welding terminal 17.

Namely, in the above wire-ultrasonic joining method, the conducting portion 16 of the wire 15, consisting of the plurality of core wires, can be beforehand integrally formed into such a flat plate-shape that the integrally-formed conducting portion 16 has the width corresponding to the distance W2 between the pair of side walls 18 which is the joining width of the welding terminal 17. Therefore, there is no fear that the width of the conducting portion 16 becomes larger than the distance W2 between the pair of side walls 18, and therefore there is no fear that the conducting portion 16 fails to be set in the welding terminal, and therefore the conducting portion 16 can be positively joined to the welding terminal 17.

By adjusting the distance between the end surface 13a of the first holding member 13 and the end surface 14a of the second holding member 14, the width of the conducting portion 16, integrally formed into a flat plate-shape, can be suitably changed as at W3 in FIG. 4B, and the conducting portion can be easily suited for use with welding terminals 17 of different sizes.

And besides, the conducting portion 16 of the wire 15 is beforehand integrally formed into the flat plate-shape in such a manner that its joining width is kept to the predetermined value, and therefore it is easy to keep the area of contact between the conducting portion 16 of the wire 15 and the welding terminal 17 (which are to be joined together) to a predetermined value, and the ultrasonic joining can be suitably effected by efficiently applying the ultrasonic power to the joining portion from the ultrasonic joining machine.

Namely, when there are variations in the area of contact between the conducting portion 16 and the welding terminal 17, there is a fear that the ultrasonic power can not be suitably applied to the joining portion, so that the joining portion is not sufficiently melted, or is excessively melted, thus causing the defective joining. However, the contact area is kept to the predetermined value as described above, and by doing so, such defective joining can be prevented.

The wire-ultrasonic joining method of the present invention is not limited to the above embodiment, and various embodiments can be adopted on the basis of the subject manner of the invention.

For example, in the above embodiment, the welding terminal 17 is used as the mating connection member, and the wire 15 is joined to this connection terminal 17. However, the mating connection member of the invention is not limited to such a terminal, and the invention can be applied to any other suitable mating connection member such as a wire whose conducting portion is beforehand integrally formed into a flat plate-shape and a bus bar.

In the above embodiment, although one wire 15 in the form of a twisted wire, consisting of the plurality of conducting wires, is ultrasonic joined to the welding terminal, the invention can be applied to the case where a plurality of wires are simultaneously ultrasonic joined to a welding terminal.

What is claimed is:

1. A method of joining a wire, comprising the steps of:
providing the wire having a conducting portion consisting of a plurality of core wires;
restricting a width of the conducting portion;
pressing the core wires of the conducting portion restricted in the restricting step; and
joining the pressed core wires of the conducting portion each other so that the conducting portion is integrally formed into a flat plate-shape.

2. The method as set forth in claim 1, wherein ultrasonic vibration is applied to the pressed core wires in the joining step.

3. The method as set forth in claim 1, further comprising the steps of:
providing a connection member;
setting the conducting portion of the wire to the connection member; and
applying ultrasonic to the conducting portion and the connection member so as to join each other.
